(19) United States
(12) Patent Application Publication
(10) Pub. No.: US 2025/0261625 A1
(43) Pub. Date: Aug. 21, 2025

(54) Agricultural Sprayer With Height Sensor and Variable Duty Cycle

(71) Applicant: Centure Applications LTD, Tel Aviv-Yafo (IL)

(72) Inventors: Yuval Dishon, Tel Aviv (IL); Itzhak Khait, Vaughan (CA)

(21) Appl. No.: 19/058,268

(22) Filed: Feb. 20, 2025

Related U.S. Application Data
(60) Provisional application No. 63/555,533, filed on Feb. 20, 2024.

(51) Int. Cl. A01M 7/00

(52) U.S. Cl. CPC A01M 7/0089

(57) ABSTRACT

A spray system includes an agricultural vehicle; a spray boom attached to the agricultural vehicle; a tank storing a liquid agricultural product; spray nozzles disposed on the spray boom; fluid lines fluidly coupling the tank to a respective spray nozzle; valves fluidly coupled to a respective fluid line and having open and closed states; a height sensor disposed on the spray boom; and processor(s) in communication with the valves and the height sensor, the processor(s) configured to cause the valves to transition between the open state and the closed state at a frequency and a variable duty cycle, the variable duty cycle based at least in part on a measured height of the spray boom.

### CROSS-REFERENCE TO RELATED APPLICATIONS

This application claims priority to U.S. Provisional Application No. 63/555,533, titled “Agricultural Sprayer With Height Sensor And Variable Duty Cycle,” filed Feb. 20, 2024, which is hereby incorporated by reference.

### TECHNICAL FIELD

This application relates generally to agricultural spray systems.

### BACKGROUND

Agricultural spray systems include spray booms with nozzles to spray an agricultural field.

### SUMMARY

Example embodiments described herein have innovative features, no single one of which is indispensable or solely responsible for their desirable attributes. The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Without limiting the scope of the claims, some of the advantageous features will now be summarized. Other objects, advantages, and novel features of the disclosure will be set forth in the following detailed description of the disclosure when considered in conjunction with the drawings, which are intended to illustrate, not limit, the invention.

An aspect of the invention is directed to a spray system comprising an agricultural vehicle; a spray boom attached to the agricultural vehicle; a tank that stores a liquid agricultural product; a plurality of spray nozzles disposed on the spray boom; a plurality of fluid lines, each fluid line fluidly coupling the tank to a respective spray nozzle and to the tank; a plurality of valves, each valve fluidly coupled to a respective fluid line and having an open state in which the liquid agricultural product flows from the tank to a respective spray nozzle and a closed state in which a flow of the liquid agricultural product from the tank to the respective spray nozzle is obstructed; a height sensor disposed on the spray boom; and one or more processors in communication with the valves and the height sensor, the processor(s) configured to cause the valves to transition between the open state and the closed state at a frequency and a variable duty cycle, the variable duty cycle based at least in part on a measured height of the spray boom.

In one or more embodiments, the processor(s) is/are configured to set the variable duty cycle at a default duty cycle when the measured height is lower than or equal to an upper threshold height and greater than or equal to a lower threshold height. In one or more embodiments, the processor(s) is/are configured to set the variable duty cycle at a higher duty cycle when the measured height is greater than the upper threshold height, the higher duty cycle higher than the default duty cycle. In one or more embodiments, the processor(s) is/are configured to set the variable duty cycle at a lower duty cycle when the measured height is lower than the lower threshold height, the lower duty cycle lower than the default duty cycle.

In one or more embodiments, the spray system further comprises a plurality of height sensors height disposed on the spray boom, wherein the processor(s) is/are configured to cause first and second valves to operate at a first variable duty cycle, the first variable duty cycle based at least in part on a first measured height of the spray boom at a first position of a first height sensor associated with the first valve, and the first and second valves are neighboring valves, such that when the first measured height is greater than the upper threshold height, both the first and second valves operate at a higher duty cycle than the default duty cycle, when the first measured height is lower than the lower threshold height, both the first and second valves operate at a lower duty cycle than the default duty cycle, and when the first measured height is lower than or equal to the upper threshold height and greater than or equal to the lower threshold height, both the first and second valves operate at the default duty cycle.

In one or more embodiments, the processor(s) is/are configured to compare the measured height to a plurality of height-range thresholds, each height-range threshold having a respective upper threshold height and a respective lower threshold height and associated with a respective duty cycle, and set the variable duty cycle to a first duty cycle when the measured height is within a first height-range threshold. In one or more embodiments, the processor(s) is/are configured to determine a model duty cycle using the measured height and a duty-cycle model, and set the variable duty cycle to the model duty cycle.

In one or more embodiments, the spray nozzles comprise broadcast nozzles and/or selective spot-spray nozzles. In one or more embodiments, the tank is a broadcast tank that stores a general-application liquid agricultural product, the fluid lines are first fluid lines, the spray nozzles are broadcast nozzles, the valves are first valves, the frequency is a first frequency, the variable duty cycle is a first variable duty cycle, and the system further comprises a plurality of selective spot-spray (SSP) nozzles disposed on the spray boom; an SSP tank that stores a target-application liquid agricultural product; a plurality of second fluid lines, each second fluid line fluidly coupling the SSP tank to a respective SSP nozzle; and a plurality of second valves, each second valve fluidly coupled to a respective second fluid line and having the open state and the closed state, wherein the processor(s) is/are in communication with the second valves, the processor(s) configured to cause the second valves to transition between the open state and the closed state at a second frequency and a second variable duty cycle, the second variable duty cycle based at least in part on the measured height of the spray boom.

Another aspect of the invention is directed to a spray system comprising an agricultural vehicle; a spray boom attached to the agricultural vehicle; a tank that stores a liquid agricultural product; a plurality of spray nozzles disposed on the spray boom; a plurality of fluid lines, each fluid line fluidly coupling the tank to a respective spray nozzle and to the tank; a plurality of valves, each valve fluidly coupled to a respective fluid line and having an open state in which the liquid agricultural product flows from the tank to a respective spray nozzle and a closed state in which a flow of the liquid agricultural product from the tank to the respective spray nozzle is obstructed; a plurality of height sensors disposed on the spray boom, each height sensor associated with a group of the valves; and one or more processors in electrical communication with the valves and the height sensors, the processor(s) configured to cause each group of valves to transition between the open state and the closed state at a respective frequency and at a respective variable duty cycle, the respective variable duty cycle based at least in part on a respective measured height of the spray boom at a respective position of a respective height sensor.

In one or more embodiments, the processor(s) is/are configured to set the respective variable duty cycle at a default duty cycle when the respective measured height is lower than or equal to an upper threshold height and greater than or equal to a lower threshold height. In one or more embodiments, the processor(s) is/are configured to set the respective variable duty cycle at a higher duty cycle when the respective measured height is greater than the upper threshold height, the higher duty cycle higher than the default duty cycle. In one or more embodiments, the processor(s) is/are configured to set the respective variable duty cycle at a lower duty cycle when the respective measured height is lower than the lower threshold height, the lower duty cycle lower than the default duty cycle.

In one or more embodiments, the processor(s) is/are configured to compare the respective measured height to a plurality of height-range thresholds, each height-range threshold having a respective upper threshold height and a respective lower threshold height and associated with a corresponding duty cycle, and set the respective variable duty cycle to a first duty cycle when the respective measured height is within a first height-range threshold.

In one or more embodiments, the processor(s) is/are configured to determine a respective model duty cycle using the respective measured height and a duty-cycle model, and set the respective variable duty cycle to the respective model duty cycle. In one or more embodiments, the spray nozzles comprise broadcast nozzles and/or selective spot-spray nozzles.

Another aspect of the invention is directed to a spray system comprising an agricultural vehicle; a spray boom attached to the agricultural vehicle; a broadcast tank that stores a general-application liquid agricultural product; a selective-spot sprayer (SSP) tank that stores a specific-application liquid agricultural product; a plurality of broadcast nozzles disposed on the spray boom; a plurality of SSP nozzles disposed on the spray boom; a plurality of first fluid lines, each first fluid line fluidly coupling the broadcast tank to a respective broadcast spray nozzle; a plurality of second fluid lines, each second fluid line fluidly coupling the SSP tank to a respective SSP spray nozzle; a plurality of first valves, each first valve fluidly coupled to a respective first fluid line and having an open state and a closed state; a plurality of second valves, each second valve fluidly coupled to a respective second fluid line and having the open state and the closed state; a plurality of height sensors disposed on the spray boom, each height sensor associated with a respective group of the first and second valves; and one or more processors in electrical communication with the first and second valves and the height sensors, the processor(s) configured to cause the first valves of each group to transition between the open state and the closed state at a respective first frequency and at a respective first variable duty cycle, the respective first variable duty cycle based at least in part on a respective measured height of the spray boom at a respective position of a respective height sensor, and cause the second valves of each group to transition between the open state and the closed state at a respective second frequency and at a respective second variable duty cycle, the respective second variable duty cycle based at least in part on the respective measured height of the spray boom.

### BRIEF DESCRIPTION OF THE DRAWINGS

For a fuller understanding of the nature and advantages of the concepts disclosed herein, reference is made to the detailed description of preferred embodiments and the accompanying drawings.

FIG. 1 is an isometric view of a dual-sprayer system 10 according to one or more embodiments.

FIG. 2 is a side view of a dual-sprayer system according to one or more embodiments.

FIG. 3 is a block diagram of a system for selectively applying a treatment to a target region according to one or more embodiments.

FIG. 4 is a simplified block diagram of fluid and electrical circuits for a dual-sprayer system according to one or more embodiments.

FIG. 5A is a simplified illustration of a spray boom having a first measured height.

FIG. 5B illustrates an example spray pattern of a spray nozzle on the spray boom illustrated in FIG. 5A.

FIG. 6 is a simplified illustration of a spray boom having a second measured height.

FIG. 7 is a simplified illustration of a spray boom having a third measured height.

FIG. 8 is a simplified block diagram of fluid and electrical circuits for a dual-sprayer system according to one or more embodiments.

FIG. 9 is a flow chart of a method for spraying an agricultural field using a variable duty cycle.

### DETAILED DESCRIPTION

A height sensor is coupled to an agricultural sprayer that includes one or more spray nozzles. The height sensor can be attached to a spray boom, a frame, or another structure associated with the spray nozzle(s). The duty cycle(s) of the spray nozzle(s) and/or valve(s) fluidly coupled to the spray nozzle(s) can be varied based on the output (e.g., measured height) of the height sensor.

In one example, the duty cycle can have a default (e.g., first) value when the measured height is greater than or equal to a lower threshold height and lower than or equal to an upper threshold height. The duty cycle can have a higher value when the measured height is greater than the upper threshold height and can have a lower value when the measured height is lower than the lower threshold height. In other examples, there can be additional threshold heights and additional respective duty cycles. In another example, the duty cycle can vary with respect to the measured height according to a model.

In some embodiments, multiple height sensors can be coupled to the agricultural sprayer. Each height sensor can be associated with one or more respective spray nozzles such that the measured height of a given height sensor can be used as an input to vary the duty cycle of the respective spray nozzle(s) associated with the height sensor. Additionally or alternatively, the outputs of the multiple height sensors can be statistically combined, such as a mean or median, to vary the duty cycle of some or all of the spray nozzle(s).

The spray nozzle(s) can be selective spot spray nozzles and/or broadcast nozzles. In some embodiments, the spray nozzles are mounted on an agricultural spray boom that is attached to an agricultural vehicle, such as a tractor.

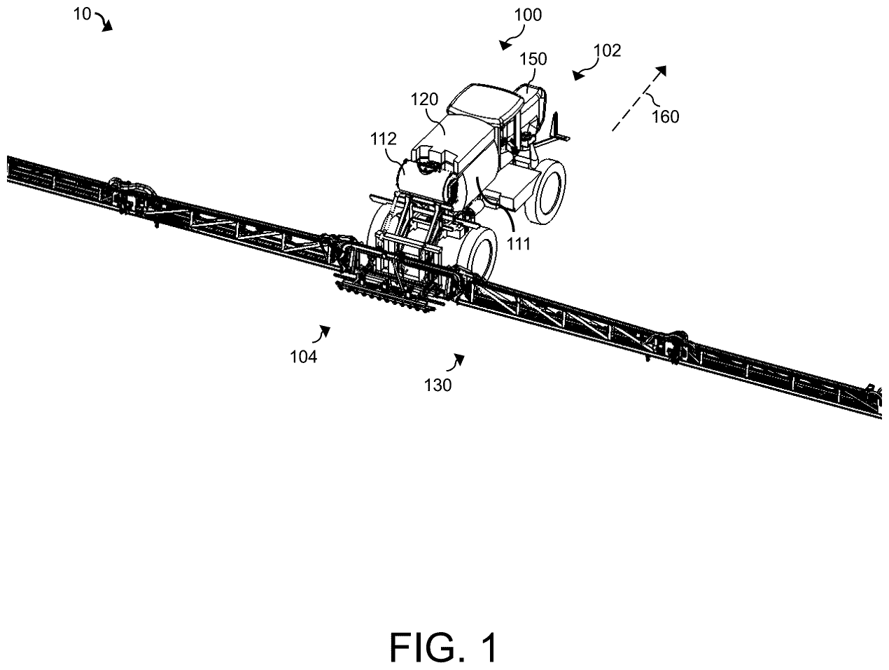

FIG. 1 is an isometric view of a dual-sprayer system 10 according to one or more embodiments. The system 10 includes an agricultural vehicle 100, a broadcast tank 111, a selective-spot spray (SSP) tank 112, a rinse tank 120, and a spray boom 130.

The broadcast tank 111 is mounted on the agricultural vehicle 100 and is configured to hold one or more general-application liquid agricultural products (e.g., one or more herbicides such as one or more residual herbicides, one or more fungicides, one or more insecticides, one or more nematicides, one or more pesticides, and/or one or more fertilizers) to be sprayed broadly onto an agricultural field using the spray boom 130, which is attached to the agricultural vehicle 100. One or more first fluid lines fluidly couple the broadcast tank 111 to one or more broadcast nozzles on the spray boom 130. Valve(s) coupled to the broadcast nozzle(s) can be opened and closed at a frequency and at a variable duty cycle to control the application rate (typically measured in gallons per acre (GPA)) of the general-application liquid agricultural product(s)). The duty cycle can be varied according to the height of the spray boom 130 and/or the height of each broadcast nozzle to maintain a uniform or substantially uniform (e.g., within about 5% to about 10%) application rate of the general-application liquid agricultural product(s). The duty cycle can also be varied according to the speed of the agricultural vehicle 100.

The SSP tank 112 is mounted on the agricultural vehicle 100 and is configured to hold one or more target-application or specific liquid agricultural products (e.g., one or more herbicides such as one or more non-residual herbicides, one or more fungicides, one or more insecticides, one or more nematicides, and/or one or more pesticides) that is/are designed to target one or more weeds growing and/or one or more pests and/or fungi in the agricultural field (in general, one or more target features in the agricultural field). Additionally or alternatively, the specific liquid agricultural products can include one or more fertilizers and/or nitrogen-containing compounds. One or more second fluid lines fluidly couple the SSP tank to one or more SSP nozzles on the spray boom 130. The specific chemical(s) in the SSP tank 112 are selectively sprayed using the SSP nozzle(s) in response to imaging of the agricultural field and analysis/detection by one or more trained machine learning models. Valve(s) coupled to the SSP nozzle(s) can be opened and closed to selectively spray the detected weeds. When the valve(s) are activated, the valve(s) can be repeatedly opened and closed at a frequency and at a variable duty cycle. The duty cycle can be varied according to the height of the spray boom 130 and/or the height of each SSP nozzle to maintain a uniform or substantially uniform (e.g., within about 5% to about 10%) application rate of the or specific liquid agricultural product(s). The duty cycle can also be varied according to the speed of the agricultural vehicle 100. The frequency and/or the duty cycle of the SSP nozzles can be the same as or different than the frequency and/or the duty cycle of the broadcast nozzles, respectively.

The rinse tank 120 is fluidly coupled to the broadcast tank 111 and to the SSP tank 112. Water and/or another liquid stored in the rinse tank 120 can be used to rinse the broadcast tank 111 and/or the SSP tank 112 after each tank 111, 112 is emptied.

The engine 150 for the agricultural vehicle 100 can be replaced with a motor when the agricultural vehicle 100 is electric or can include both an engine and a motor when the agricultural vehicle 100 is a hybrid vehicle. In any case, the agricultural vehicle 100 includes a mechanical drive system that powers the agricultural vehicle 100 and the wheels.

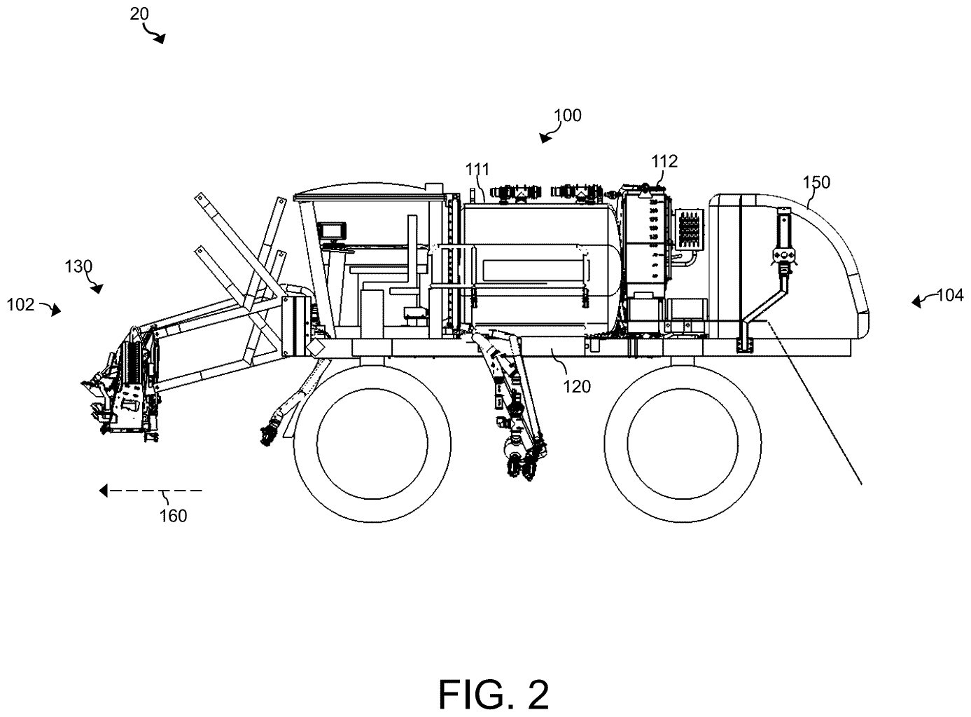

The spray boom 130 is attached to the back 104 of the agricultural vehicle 100 in a first configuration such that the agricultural vehicle 100 pulls the spray boom 130 as the agricultural vehicle 100 drives forward (e.g., in direction 160), as illustrated in FIG. 1. In a second configuration, the spray boom 130 can be attached to the front 102 of the agricultural vehicle 100 such that the agricultural vehicle 100 pushes the spray boom 130 as the agricultural vehicle 100 drives forward. An example of the second configuration is illustrated in FIG. 2, which is a side view of a dual sprayer system 20 according to another embodiment. System 20 is the same as system 10 except for the locations of the broadcast tank 111, the SSP tank 112, and the rinse tank 120 and the configuration/location of the spray boom 130.

The broadcast tank 111, the first fluid lines, respective valves, and broadcast nozzles can be optional in some embodiments such that the dual-sprayer system 10 is a single-sprayer system that only includes SSP nozzles and associated equipment. The SSP tank 112, the second fluid lines, respective valves, and the SSP nozzles can be optional in other embodiments such that the dual-sprayer system 10 is a single-sprayer system that only includes broadcast nozzles and associated equipment.

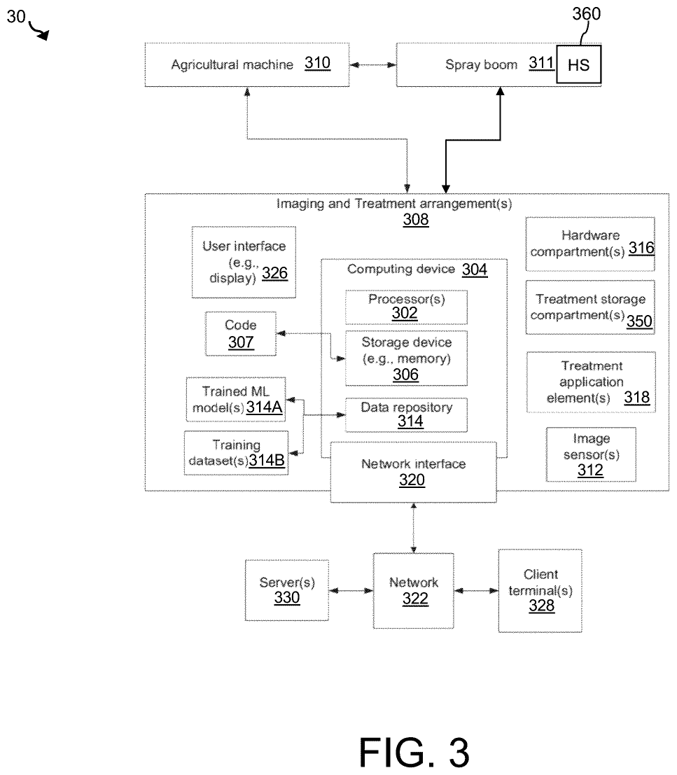

FIG. 3 is a block diagram of a system 30 for selectively applying a treatment to a target region according to one or more embodiments. System 30 can be the same as system 10 and/or system 20.

System 30 includes one or more imaging and treatment arrangements 308 connected to and/or mounted on an agricultural machine 310, for example, a tractor, an airplane, an off-road vehicle, or a drone. Agricultural machine 310 can be the same as agricultural machine 100. Agricultural machine 310 can include and/or can be connected to a spray boom 311 and/or to another boom. Spray boom 311 can be the same as spray boom 130. Imaging and treatment arrangements 308 may be arranged along a length of the agricultural machine 310 and/or of the spray boom 311. For example, the imaging and treatment arrangements 308 can be evenly spaced every 1-3 meters along the length of spray boom 311. Spray boom 311 may be long, for example, 10-50 meters, or another length. Spray boom 311 may be pushed or pulled by agricultural machine 310. In another embodiment, the system 30 only includes one imaging and treatment arrangement 308. One or more height sensors 360 is/are mounted on or attached to the spray boom 311.

An example imaging and treatment arrangement 308 is depicted for clarity, but it is to be understood that system 30 may include multiple imaging and treatment arrangements 308. It is noted that each imaging and treatment arrangement 308 may include all components described herein. Alternatively, one or more imaging and treatment arrangements 308 can share one or more components, for example, multiple imaging and treatment arrangements 308 can share a common computing device 304, common memory 306, and/or common processor(s) 302.

Each imaging and treatment arrangement 308 includes one or more image sensors 312 that acquire images of the agricultural field. Examples of an image sensor 312 include a color sensor, optionally a visible light-based sensor, for example, a red-green-blue (RGB) sensor such as CCD and/or CMOS sensors, and/or other cameras (e.g., cameras 440) and/or other sensors such as an infra-red (IR) sensor, a near-infrared sensor, an ultraviolet sensor, a fluorescent sensor, a LIDAR sensor, an NDVI sensor, a three-dimensional sensor, and/or a multispectral sensor. Image sensor(s) 312 are arranged and/or positioned to capture images of a portion of the agricultural field (e.g., located in front of image sensor(s) 312 and along a direction of motion of agricultural machine 310).

A computing device 304 receives the image(s) from image sensor(s) 312, for example, via a direct connection (e.g., local bus and/or cable connection and/or short-range wireless connection), a wireless connection and/or via a network. The image(s) are processed by processor(s) 302, which feeds the image into a trained machine learning (ML) model 314A (e.g., trained on a training dataset(s) 314B that include training images of agricultural fields with one or more target features, such as target weeds, target pests/insects, target fungi and training images of agricultural fields without any target features). Training dataset(s) 314B are used to train an untrained ML model to create the trained ML model 314A and may not be included in system 30 in some embodiments.

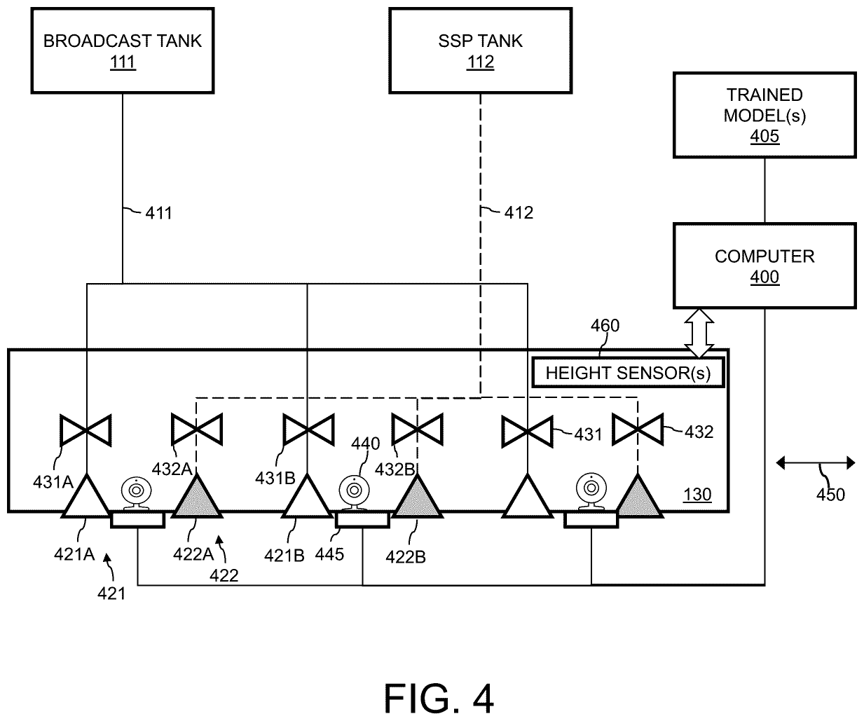

The trained ML model 314A can be configured to detect a target feature, such as one or more weeds, one or more target pests/insects, and/or one or more target fungi, within the image(s), that is separate from a desired growth (e.g., a crop). Additionally or alternatively, the trained ML model 314A can be configured to detect one or more target agricultural crops. One treatment storage compartment 350 may be selected from multiple treatment storage compartments according to the outcome of trained ML model 314A, for administration of a treatment by one or more treatment application element(s) 318, as described herein. For example, an SSP tank (e.g., SSP tank 112) can be selected to provide treatment in response to the detection of a target weed (and/or another target feature). In some embodiments, only the SSP valve(s) 432 (FIG. 4) associated with the camera 440 (FIG. 4) (or other image sensor(s) 312) and with the position(s) (e.g., based on the field-of-view of the image sensor 312 that acquired the image in which the target weed (and/or another target feature) is detected) of the detected weed (and/or another target feature) in the image(s) are activated to precisely target the detected weed. In contrast, the broadcast tank (e.g., broadcast tank 111) can be used to continually apply treatment to all or substantially all areas of the agricultural field, for example as a preventative for future weed growth and/or as a general herbicide. The application of the agricultural field using a broadcast tank and/or an SSP tank can include applying the liquid agricultural products at a respective duty cycle and a respective frequency, which can be a respective variable duty cycle and/or a respective variable frequency. The respective variable duty cycle is based, at least in part (e.g., wholly or partially), on the height of the spray boom 311 as measured by the height sensor(s) 360.

Hardware processor(s) 302 of computing device 304 may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 302 may include a single processor, or multiple processors (homogenous or heterogeneous) arranged for parallel processing, as clusters and/or as one or more multi core processing devices.

Storage device (e.g., memory) 306 stores code instructions executable by hardware processor(s) 302, for example, a random-access memory (RAM), read-only memory (ROM), and/or a storage device, for example, non-volatile memory, magnetic media, semiconductor memory devices, hard drive, removable storage, and optical media (e.g., DVD, CD-ROM). Memory 306 stores code 307 that implements one or more features and/or instructions to be executed by the hardware processor(s) 302. Memory 306 can comprise or consist of solid-state memory and/or a solid-state device.

Computing device 304 may include a data repository 314 (e.g., storage device(s)) for storing data, for example, trained ML model(s) 314A which may include a detector component and/or a classifier component. The data repository 314 also stores the captured real-time images taken with the respective image sensor 312. The data repository 314 may be implemented as, for example, a computer memory, a local hard-drive, a solid-state drive, a solid-state memory, virtual storage, a removable storage unit, an optical disk, a storage device, and/or as a remote server and/or computing cloud (e.g., accessed using a network connection). Additional details regarding the trained ML model(s) 314A, the training dataset(s) 314B, and/or other components of system 30 are described—in U.S. Pat. No. 11,393,049, titled “Machine Learning Models For Selecting Treatments For Treating an Agricultural Field,” which is hereby incorporated by reference.

Computing device 304 is in communication with one or more treatment storage compartment(s) (e.g., tanks) 350 and/or treatment application elements 318 (e.g., including respective valves such as valves 431, 432) that apply treatment for treating the field and/or plants growing on the field. There may be two or more treatment storage compartment(s) 350, for example, one or more compartments (e.g., SSP tank 112) storing chemical(s) specific to a target growth such as one or more weeds, and another one or more compartments (e.g., broadcast tank 111) storing broad chemical(s) that are non-specific to target growths such as designed for different types of target features such as weeds, pests/insects, fungi, and/or for the prevention of such target features. One or more of the treatment storage compartment(s) 350 can comprise a portion of a direct injection system. In an embodiment, the system 30 can include a first direct injection system for the chemical(s) specific to a target feature (e.g., one or more weeds) and/or a second direct injection system for the broad chemical(s) that are non-specific to target features.

There may be one or multiple treatment application elements 318 connected to the treatment storage compartment(s) 350, for example, one or more spot sprayers connected to a first compartment (e.g., SSP tank 112) storing specific chemicals for one or more target features (e.g., weeds, pests/insects, fungi, etc.) and one or more broadcast sprayers (e.g., broadcast nozzles 421 (FIG. 4)) connected to a second compartment (e.g., broadcast tank 111) storing non-specific chemicals for different types of weeds. A respective valve (e.g., valve 431 or valve 432 (FIG. 4)) can be opened and closed to drive fluid through each broadcast sprayer nozzle(s) or each SSP nozzle(s) 422 (FIG. 4). Alternatively, each spot sprayer and/or each broadcast sprayer can include a respective valve. The valves can be opened and closed at a respective frequency and at a respective variable duty cycle as described herein. The computing device 304 can determine and/or set the variable duty cycle of the valves.

Computing device 304 and/or imaging and treatment arrangement 308 may include a network interface 320 for connecting to a network 322, for example, one or more of, a network interface card, an antenna, a wireless interface to connect to a wireless network, a physical interface for connecting to a cable for network connectivity, a virtual interface implemented in software, network communication software providing higher layers of network connectivity, and/or other implementations.

Computing device 304 and/or imaging and treatment arrangement 308 may communicate with one or more client terminals 328 (e.g., smartphones, mobile devices, laptops, smart watches, tablets, desktop computer) and/or with a server(s) 330 (e.g., web server, network node, cloud server, virtual server, virtual machine) over network 322. Client terminals 328 may be used, for example, to remotely monitor imaging and treatment arrangement(s) 308 and/or to remotely change parameters thereof. Server(s) 330 may be used, for example, to remotely collect data from multiple imaging and treatment arrangement(s) 308 optionally of different agricultural machines, for example, to create new training datasets and/or update exiting training datasets for updating the trained ML model(s) 314A with new images.

Network 322 may be implemented as, for example, the internet, a local area network, a wire-area network, a virtual network, a wireless network, a cellular network, a local bus, a point-to-point link (e.g., wired), and/or combinations of the aforementioned.

Computing device 304 and/or imaging and treatment arrangement 308 includes and/or is in communication with one or more physical user interfaces 326 that include a mechanism for user interaction, for example, to enter data (e.g., define threshold and/or set of rules) and/or to view data (e.g., results of which treatment was applied to which portion of the field).

Example physical user interfaces 326 include, for example, a touchscreen, a display, gesture activation devices, a keyboard, a mouse, and/or voice-activated software using speakers and a microphone. Alternatively, client terminal 328 serves as the user interface by communicating with computing device 304 and/or server 330 over network 322.

Treatment application elements 318 may be adapted for spot spraying and/or broad (e.g., band) spraying, for example as described in U.S. Provisional Patent Application No. 63/149,378, filed on Feb. 15, 2021, and/or in U.S. Pat. No. 11,393,049, which are hereby incorporated by reference.

System 30 may include a hardware component 316 associated with the agricultural machine 310 for dynamic adaption of the liquid agricultural products applied by the treatment application element(s) 318 according to dynamic orientation parameter(s) computed by analyzing an overlap region of images captured by image sensors 312, for example as described in U.S. Provisional Patent Application No. 63/082,500, filed on Sep. 24, 2020, and/or in U.S. Pat. No. 11,393,049, which are hereby incorporated by reference.

FIG. 4 is a simplified block diagram of fluid and electrical circuits for a dual-sprayer system 10, 20, 30 according to one or more embodiments. One or more fluid lines 411 (e.g., first fluid lines) fluidly couple the broadcast tank 111 to a plurality of broadcast nozzles 421 on the spray boom 130. One or more fluid lines 412 (e.g., second fluid lines) fluidly couple the SSP tank 112 to a plurality of SSP nozzles 422 on the spray boom 130. The spray boom 130 extends along and/or parallel to a horizontal axis 450. Electromechanically actuated valves 431 (e.g., broadcast valves) are located on and/or fluidly coupled to the fluid line(s) 411 between each broadcast nozzle 421 and the broadcast tank 111. Electromechanically actuated valves 432 (e.g., SSP valves) are located on and/or fluidly coupled to the fluid line(s) 412 between each SSP nozzle 422 and the SSP tank 112.

Each valve 431, 432 can include a solenoid that allows the respective valve 431, 432 to open and close at a respective frequency and a respective variable duty cycle. In some embodiments, there may be only one SSP nozzle 422 and/or only one broadcast nozzle 421.

Lights 445 such as light-emitting diodes (LEDs) can be used provide light (e.g., flash) for the agricultural field. The cameras 440 and lights 445 are in electrical communication with the computer/controller 400 to detect weeds in the images using one or more trained machine learning models 405. The trained model(s) 405 can be trained using first images of the target weeds and second images that do not include the target weeds. The trained model(s) 405 can be the same as trained ML model(s) 314A. The field of view of each camera 440 and/or other image sensor(s) is aligned with and corresponds to the position of one or more SSP nozzles 422.

The fluid circuits for the broadcast tank 111 and the SSP tank 112 can include additional components, such as pumps, filters, sensors, and/or other components.

The state of each valve 431, 432 is controlled by a computer or controller 400 which is electrically coupled to each valve 431, 432. The computer/controller 400 can be the same as computing device 304. Additional computers and/or controllers can be provided. The computer/controller 400 selectively activates one or more valves 432 when one or more trained ML models (e.g., trained ML model(s) 314A) detect targeted features in the images obtained by cameras 440 and/or other image sensors (e.g., image sensor(s) 312) mounted on the spray boom 130, 311. The valve(s) 432 selected to be opened is/are determined based on which camera 400 acquired the image and/or the location of the detected target feature within the image. The valves 431 are typically only in an activated state but can transition to an inactivated state as needed. In the activated state, the valves 431, 432 repeatedly open and close at a respective frequency and at a respective variable duty cycle. In an inactivated state, the valves 431, 432 are closed. The respective frequency can be variable in some embodiments. The frequency and/or the duty cycle of some or all of the valves 431 can be the same as or different than the frequency and/or the duty cycle of some or all of the valves 432, respectively.

In some embodiments, the frequency of the valve(s) 431 and/or 432 can be high such as greater than or equal to 45 Hz, such as 45 Hz to 100 Hz. In some embodiments, the valve(s) 431 and/or 432 can operate at a high pressure (e.g., a constant high pressure) of at least about 50 PSI such as about 50 PSI to about 100 PSI including any value or range therebetween. In some embodiments, the broadcast nozzles 421 and/or the SSP nozzles 422 can produce Xtra/ultra-coarse droplets (e.g., having a mean volume diameter (VD₅₀) of at least 500 microns, such as 500 microns to 1,000 microns including any value or range therebetween) at high pressure (e.g., a constant high pressure) of at least about 50 pounds per square inch (PSI).

The valves 431, 432 have a variable duty cycle and/or a variable frequency when in the activated state. The variable duty cycle and/or the variable frequency can correspond or relate to the speed of the agricultural vehicle 100, 310 such that the respective agricultural product is applied at the same or approximately the same rate (e.g., GPA) regardless of the speed of the agricultural vehicle 100, 310. The computer 400 can include or can be electrically coupled to one or more pulse-width modulator (PWM) signal generators that can produce the control signals that vary the frequencies and/or duty cycles of the valves 431, 432.

One or more height sensors 460 is/are located on (e.g., mounted on and/or attached to) the spray boom 130. The output(s) of the height sensor(s) is/are in electrical communication with the computer 400 or another computer. The computer 400 is configured to vary the duty cycle of the valves 431 and/or of the valves 432, when they are in the activated state, based at least in part on the height measured by the height sensor(s) 460 to maintain a uniform or substantially uniform (e.g., within about 5% to about 10%) application rate of the respective liquid agricultural product(s).

The height sensor(s) 460 can include ultrasound device(s) and/or sensor(s), LiDAR (Light Detection and Ranging) device(s), and/or other height sensor(s). Additionally or alternatively, the height can be determined using image triangulation. When the height is determined using image triangulation, the height sensor(s) 460 can be optional.

In one example, the computer 400 compares the measured height with an upper threshold height and a lower threshold height. When the measured height is lower than or equal to the upper threshold height and higher than or equal to the lower threshold height, the computer 400 can cause the valves 431 and/or the valves 432 to operate at a first duty cycle, which can be a default duty cycle. When the measured height is higher than the upper threshold height, the computer 400 can cause the valves 431 and/or the valves 432 to operate at a second duty cycle that is higher than the first/default duty cycle. The second duty cycle can alternately be referred to as a higher duty cycle. When the measured height is lower than the lower threshold height, the computer 400 can cause the valves 431 and/or the valves 432 to operate at a third duty cycle that is lower than the first/default duty cycle. The third duty cycle can alternately be referred to as a lower duty cycle.

The measured height and/or the height thresholds can be calibrated according to the relative position (e.g., height) of the height sensor(s) 460 compared to the relative position(s) (e.g., height) of the broadcast nozzle(s) 421 and/or of the SSP nozzle(s) 422.

In a specific example, the default duty cycle can be 70%, the upper threshold height is 35 inches, and the lower threshold height is 12 inches. When the measured height is above 35 inches, the duty cycle can be increased to 100%. When the measured height is below 12 inches, the duty cycle can be reduced, such as by 20% of the default cycle (e.g., to 56% in this example). Other threshold heights and/or other duty cycles can be used in other embodiments.

In another example, there can be multiple threshold heights, such that the duty cycle is varied in multiple increments across multiple height-range thresholds. For example, there can be anywhere from 3 to 10 threshold heights, each threshold height having a corresponding (and different) duty cycle. A specific example may be implemented according to Table 1. Other examples having a different number of threshold heights and/or different duty cycles can be implemented.

TABLE 1

| Threshold | | |
|---|---|---|
| Height | Condition (Height-Range Threshold) | Duty Cycle |
| 10 inches | Measured Height < 10 inches | 50% |
| 15 inches | 10 inches ≤ Measured Height ≤ 20 inches | 60% |
| 20 inches | 20 inches < Measured Height ≤ 30 inches | 70% |
| 30 inches | 30 inches < Measured Height ≤ 40 inches | 90% |
| 40 inches | Measured Height > 40 inches | 100% |

In another example, the duty cycle can vary with respect to the measured height according to a model. In another example, the duty cycle can vary with respect to the measured height of the spray boom 130 and the measured speed of the agricultural vehicle according to a model. The model can be a first-degree polynomial model (e.g., a linear model), a second-degree polynomial model (e.g., a quadratic model), or another polynomial model. In general, the duty cycle increases with increased measured height and/or increased measured speed and, the duty cycle decreases with decreased measured height and/or decreased measured speed.

When multiple height sensors 460 are included, each height sensor 460 can be associated with one or more respective broadcast nozzles 421, one or more respective SSP nozzles 422, one or more respective valves 431, and/or one or more respective valves 432. The measured height from a given height sensor 460 can be used to adjust the duty cycle of the valve(s) 431 for the respective broadcast nozzle(s) 421 and/or of the valve(s) 432 for the respective SSP nozzle(s) 422.

In one or more embodiments, a first height sensor 460 can be associated with a first spray nozzle (e.g., a first broadcast nozzle 421A or a first SSP nozzle 422A) or a first valve (e.g., a first valve 431A or a first valve 432A). The variable duty cycle of the first spray nozzle can be based, at least in part, on a height (e.g., a first height) measured by the first height sensor 460. The first valve and, optionally, a neighboring second valve (e.g., a second valve 431B or a second valve 432B) can operate at the same variable duty cycle. The first valve the neighboring second valve can be associated with and/or fluidly coupled to the same type of spray nozzle. For example, when the first valve is a first valve 431A that is associated with and/or fluidly coupled to a first broadcast nozzle 421A, the neighboring second valve is a second valve 431B that is associated with and/or fluidly coupled to a second broadcast nozzle 421B. In another example, when the first valve is a first valve 432A that is associated with and/or fluidly coupled to a first SSP nozzle 422A, the neighboring second valve is a second valve 432B that is associated with and/or fluidly coupled to a second SSP nozzle 422B.

For example, when the measured height is greater than the upper threshold height, the first valve and, optionally, the neighboring second valve can operate at a higher duty cycle than the default duty cycle. When the first measured height is lower than the lower threshold height, the first valve and, optionally, the neighboring second valve can operate at a lower duty cycle than the default duty cycle. When the first measured height is greater than or equal to the lower threshold height and lower than or equal to the upper threshold height, the first valve and, optionally, the neighboring second valve operate at the default duty cycle.

Additionally or alternatively, the measured heights from multiple height sensors 460 can be statistically combined (e.g., as an average, median, or another statistic) to adjust the duty cycle of the valve(s) 431 for the broadcast nozzle(s) 421 associated with the multiple height sensors 460 and/or of the valve(s) 432 for the respective SSP nozzle(s) 422 associated with the multiple height sensors 460.

It is noted that the duty cycle(s) of the valves 431, 432 can be determined independently or collectively. For example, each valve 431 can have a duty cycle that can be determined independently (e.g., based on the measured heights from different/respective height sensors 460). Alternatively, the duty cycle for two or more valves 431 can be determined together (e.g., based on a common measured height or a measured height statistic). Each valve 432 can have a duty cycle that can be determined independently (e.g., based on the measured heights from different/respective height sensors 460). Alternatively, the duty cycle for two or more valves 432 can be determined together (e.g., based on a common measured height or a measured height statistic). The duty cycle for one or more valves 431 can be determined independently or together with the duty cycle for one or more valves 432.

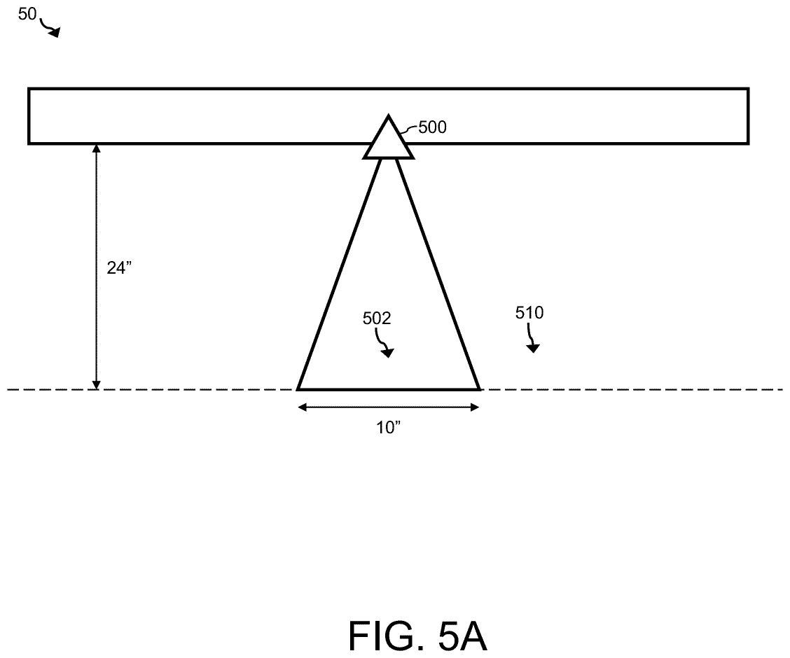

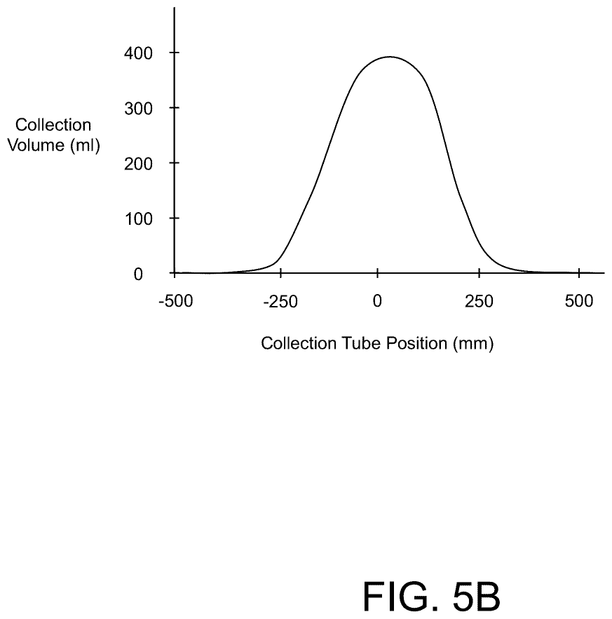

FIG. 5A is a simplified illustration of a spray boom 50 having a measured height of 24 inches, which can be the same (or about the same) height that a spray nozzle 500 was calibrated to spray at a predetermined spray rate (e.g., GPA) at a predetermined pressure using a predetermined duty cycle and frequency. At a measured height of 24 inches, the spray nozzle 500 sprays an area 502 of the agricultural field 510 that is about 10 inches in diameter. The predetermined spray rate is determined based on the volume of liquid agricultural product sprayed divided by the spray area 502 of the 10-inch circle. The spray nozzle 500 can be a broadcast nozzle 421 or an SSP nozzle 422.

In some embodiments, the spray nozzle 500 (e.g., valve) can have a high frequency (e.g., at least about 45 Hz such as about 45 Hz to about 100 Hz including any value or range therebetween). In some embodiments, the spray nozzle 500 can operate at a high pressure (e.g., a constant high pressure) of at least about 50 PSI such as about 50 PSI to about 100 PSI including any value or range therebetween. In some embodiments, the broadcast nozzles 421 and/or the SSP nozzles 422 can produce Xtra/ultra-coarse droplets (e.g., having a mean volume diameter (VD50) of at least 500 microns, such as 500 microns to 1,000 microns including any value or range therebetween) at high pressure (e.g., a constant high pressure) of at least about 50 PSI.

FIG. 5B illustrates an example spray pattern of the nozzle 500 at the measured height of 24 inches.

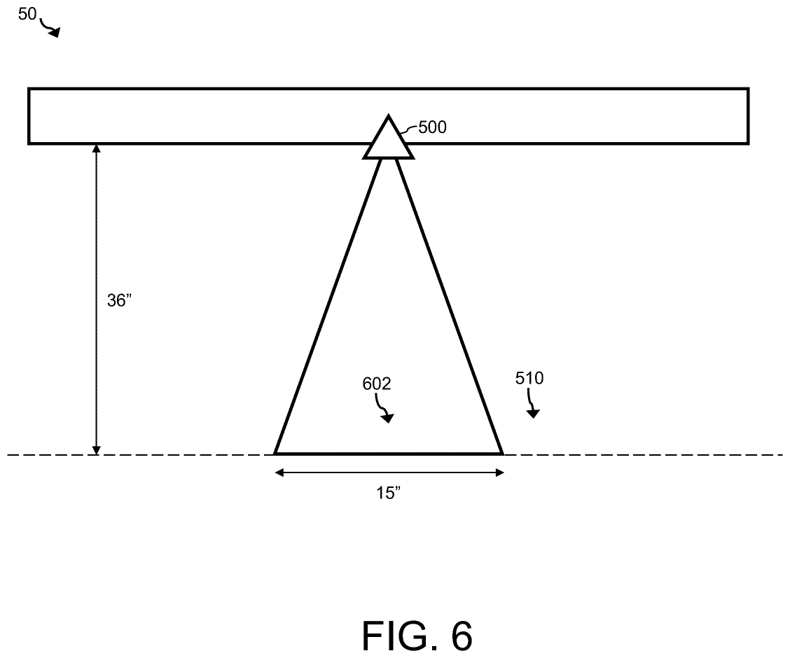

FIG. 6 is a simplified illustration of the spray boom 50 having a measured height of 36 inches. At this height, the spray nozzle 500 sprays an area 602 of the agricultural field that is about 15 inches in diameter. If the same volume of liquid agricultural product were sprayed over spray area 602 as over spray area 502 (e.g., the duty cycle of the valve for spray nozzle 500 is the same in FIGS. 5 and 6), spray area 602 would receive a lower GPA of liquid agricultural product compared to spray area 502. To compensate for the larger spray area 602, the duty cycle of the valve for spray nozzle 500 can be increased compared to the duty cycle used to spray the smaller spray area 502. The increased duty cycle results in a higher volume of liquid agricultural product applied to spray area 602 such that spray area 602 receives about the same GPA of liquid agricultural product as spray area 502.

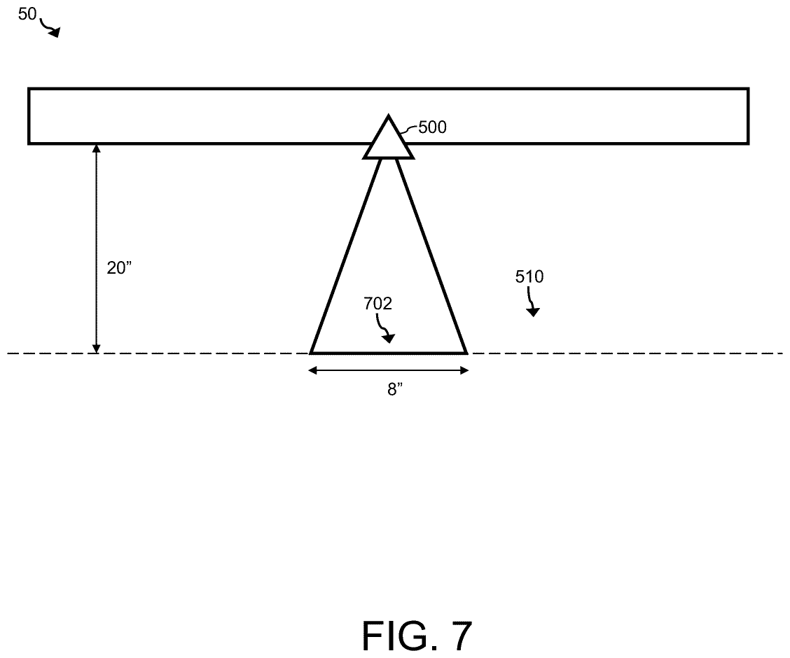

FIG. 7 is a simplified illustration of the spray boom 50 having a measured height of 20 inches. At this height, the spray nozzle 500 sprays an area 702 of the agricultural field that is about 8 inches in diameter. If the same volume of liquid agricultural product were sprayed over spray area 702 as over spray area 502 (e.g., the duty cycle of the valve for spray nozzle 500 is the same in FIGS. 5 and 7), spray area 702 would receive a higher GPA of liquid agricultural product compared to spray area 502. To compensate for the smaller spray area 702, the duty cycle of the valve for spray nozzle 500 can be decreased compared to the duty cycle used to spray the larger spray area 502. The decreased duty cycle results in a lower volume of liquid agricultural product applied to spray area 702 such that spray area 702 receives about the same GPA of liquid agricultural product as spray area 502.

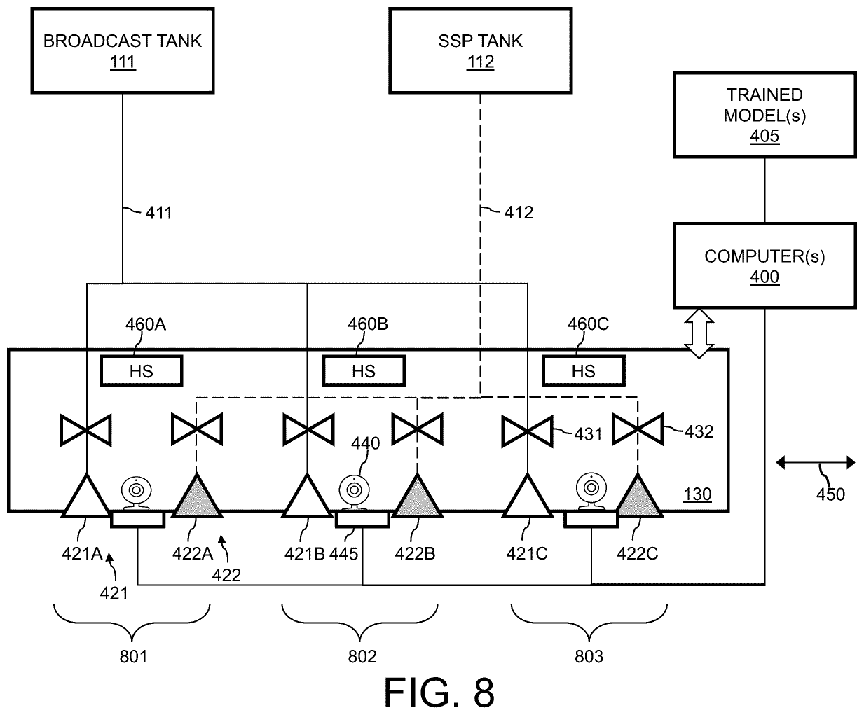

FIG. 8 is a simplified block diagram of fluid and electrical circuits for a dual-sprayer system 10, 20, 30 according to one or more embodiments. The block diagram shown in FIG. 8 is the same as that shown in FIG. 4 except that the block diagram shown in FIG. 8 includes a plurality of height sensors 460A-C. The height sensors 460A-C are spaced apart along the length of the spray boom 130 and with respect to the horizontal axis 450. Each height sensor 460A-C measures a respective height at a respective position on the spray boom 130.

An advantage of having multiple height sensors is to more accurately determine the local height of the spray boom 130 which can bend or move relative to the ground, thus providing a more uniform application rate of agricultural product to an agricultural field.

In some embodiments, each height sensor is associated with a respective group of spray nozzles. The measured height of a respective height sensor can be used to determine the duty cycle of the spray nozzles in the respective group of spray nozzles. For example, a first height sensor 460A can be associated with a first group 801 of spray nozzles that includes a first broadcast nozzle 421A and/or a first SSP nozzle 422A. A second height sensor 460B can be associated with a second group 802 of spray nozzles that includes a second broadcast nozzle 421B and/or a second SSP nozzle 422B. A third height sensor 460C can be associated with a third group 803 of spray nozzles that includes a third broadcast nozzle 421C and/or a third SSP nozzle 422C. The output of each height sensor 460A-C is in electrical or wireless communication with at least one of the computer(s) 400.

At least one of the computer(s) 400 can use the measured height (e.g., a first measured height) from the first height sensor 460A to determine the duty cycle(s) of the valves 431, 432 for the first group 801 of spray nozzles. At least one of the computer(s) 400 can use the measured height (e.g., a second measured height) from the second height sensor 460B to determine the duty cycle(s) of the valves 431, 432 for the second group 802 of spray nozzles. At least one of the computer(s) 400 can use the measured height (e.g., a third measured height) from the third height sensor 460C to determine the duty cycle(s) of the valves 431, 432 for the third group 803 of spray nozzles. The respective computer(s) 400 can cause the respective valves 431, 432 for the respective group 801-803 of spray nozzles to spray the agricultural field using the respective determined duty cycle(s).

It is noted that each valve 431, 432 for a respective group 801-803 of spray nozzles can be operated independently. For example valve 431 in group 801 can be in the active state at a first duty cycle (e.g., determined using the first measured height) over a first time period while valve 432 in group 801 can be selectively placed in the active state at a second duty cycle (e.g., determined using the first measured height) at second and third time periods, one or both of which may be within the first time period or in another time period. The first and second time periods can be the same or different than one another.

In some embodiments, a neighboring height sensor can be used as an error check on a respective height sensor. For example, at least one of the computer(s) 400 can compare a first measured height from the first height sensor 460A and a second measured height from the second height sensor 460B to determine if a difference between the first and second measured heights is lower than a predetermined maximum threshold. When the difference between the first and second measured heights is higher than or equal to the predetermined maximum threshold, the computer(s) 400 can determine that one or both of the first and second height sensors 460A, 460B may be in need or recalibration, in need of repair, and/or in need of replacement. The computer(s) 400 can produce an alert indicating that one or both of the first and second height sensors 460A, 460B may be producing an erroneous height measurement.

Additionally or alternatively, the computer(s) 400 can compare each measured height with a minimum height threshold and/or with a maximum height threshold to determine if the measured heights are within an operational range that is greater than or equal to the minimum height threshold and less than or equal to a maximum height threshold. When a measured height is outside of the operational range (i.e., less than the minimum height threshold or greater than the maximum height threshold), the computer(s) 400 cam determine that the respective height sensor may be in need or recalibration, in need of repair, and/or in need of replacement. The computer(s) 400 can produce an alert indicating a height sensor may be producing an erroneous height measurement.

In some embodiments, at least one of the computer(s) 400 can use two or more measured heights to determine a duty cycle for one or more valves of one or more respective spray nozzles including a group 801-803 of spray nozzles. The measured heights can be statistically combined such as by calculating an average, median, maximum, minimum, or other statistic of the measured heights.

Using a measured height or a measured-height statistic, at least one of the computer(s) 400 can determine a duty cycle for one or more valves in the same manner as discussed above (e.g., with respect to FIG. 4).

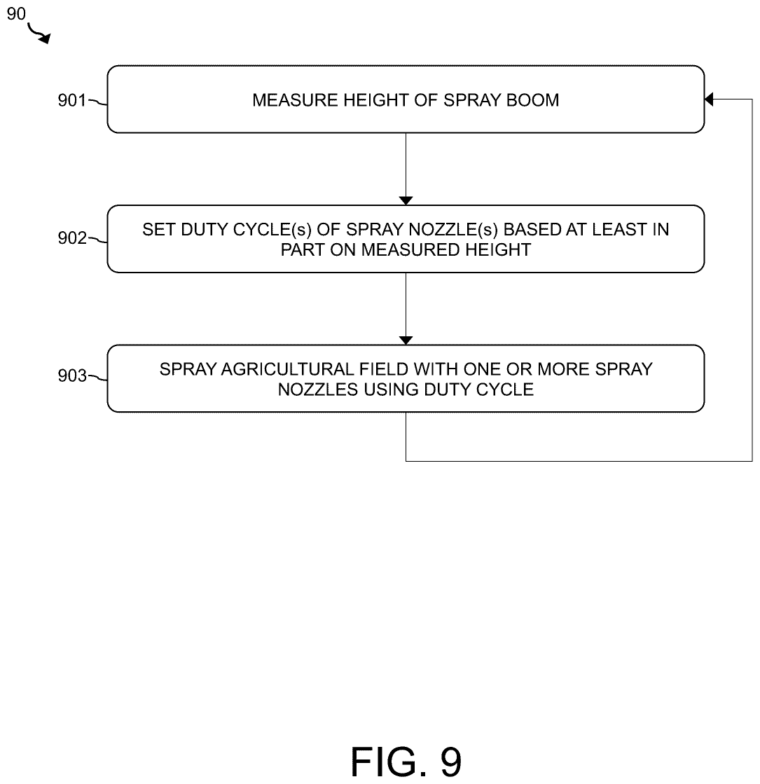

FIG. 9 is a flow chart of a method 90 for spraying an agricultural field using a variable duty cycle. In step 901, the height of the spray boom 130, 311 is measured using one or more height sensors on the spray boom 130, 311. Additionally or alternatively, the height can be measured using image triangulation.

In step 902, the duty cycle(s) of the valve(s) (e.g., valve(s) 431 and/or valve(s) 432) for one or more spray nozzles (e.g., broadcast nozzle(s) 421 and/or SSP nozzle(s) 422, respectively) on the spray boom 130, 311 are set, based at least in part, on the measured height. The duty cycle(s) of the valve(s) 431 can be the same or different than the duty cycle(s) for the valve(s) 432. When multiple height sensors are used, the measured heights can be statistically combined (e.g., mean, median, etc.) and/or used to set the duty cycle(s) of respective spray nozzles associated with each spray nozzle. The duty cycle(s) can be set based on one or more threshold heights, threshold height ranges, and/or according to a model.

In some embodiments, the duty cycle can also be varied according to the speed of the agricultural vehicle.

In step 903, one or more spray nozzles can spray the agricultural field using the duty cycle(s) determined in step 902. For example, the SSP nozzle(s) 422 associated with a target feature detected in an image can selectively spray the agricultural field using the respective duty cycle(s) determined in step 902 while any SSP nozzle(s) 422 that are not associated with a target feature do not spray the agricultural field. In another example, the broadcast nozzle(s) 421 can spray the agricultural field using the respective duty cycle(s) determined in step 902.

Steps 901-903 can be repeated as the agricultural vehicle moves across the agricultural field.

The invention should not be considered limited to the particular embodiments described above. Various modifications, equivalent processes, as well as numerous structures to which the invention may be applicable, will be readily apparent to those skilled in the art to which the invention is directed upon review of this disclosure. The above-described embodiments may be implemented in numerous ways. One or more aspects and embodiments involving the performance of processes or methods may utilize program instructions executable by a device (e.g., a computer, a processor, or other device) to perform, or control performance of, the processes or methods.

In this respect, various inventive concepts may be embodied as a non-transitory computer readable storage medium (or multiple non-transitory computer readable storage media) (e.g., a computer memory of any suitable type including transitory or non-transitory digital storage units, circuit configurations in Field Programmable Gate Arrays or other semiconductor devices, or other tangible computer storage medium) encoded with one or more programs that, when executed on one or more computers or other processors, perform methods that implement one or more of the various embodiments described above. When implemented in software (e.g., as an app), the software code may be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a Personal Digital Assistant (PDA), a smartphone or any other suitable portable or fixed electronic device.

Also, a computer may have one or more communication devices, which may be used to interconnect the computer to one or more other devices and/or systems, such as, for example, one or more networks in any suitable form, including a local area network or a wide area network, such as an enterprise network, and intelligent network (IN) or the Internet. Such networks may be based on any suitable technology and may operate according to any suitable protocol and may include wireless networks or wired networks.

Also, a computer may have one or more input devices and/or one or more output devices. These devices can be used, among other things, to present a user interface. Examples of output devices that may be used to provide a user interface include printers or display screens for visual presentation of output and speakers or other sound generating devices for audible presentation of output. Examples of input devices that may be used for a user interface include keyboards, and pointing devices, such as mice, touch pads, and digitizing tablets. As another example, a computer may receive input information through speech recognition or in other audible formats.

The non-transitory computer readable medium or media may be transportable, such that the program or programs stored thereon may be loaded onto one or more different computers or other processors to implement various one or more of the aspects described above. In some embodiments, computer readable media may be non-transitory media.

The terms “program,” “app,” and “software” are used herein in a generic sense to refer to any type of computer code or set of computer-executable instructions that may be employed to program a computer or other processor to implement various aspects as described above. Additionally, it should be appreciated that, according to one aspect, one or more computer programs that when executed perform methods of this application need not reside on a single computer or processor but may be distributed in a modular fashion among a number of different computers or processors to implement various aspects of this application.

Computer-executable instructions may be in many forms, such as program modules, executed by one or more computers or other devices. Generally, program modules include routines, programs, objects, components, data structures, etc. that performs particular tasks or implement particular abstract data types. The functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Thus, the disclosure and claims include new and novel improvements to existing methods and technologies, which were not previously known nor implemented to achieve the useful results described above. Users of the method and system will reap tangible benefits from the functions now made possible on account of the specific modifications described herein causing the effects in the system and its outputs to its users. It is expected that significantly improved operations can be achieved upon implementation of the claimed invention, using the technical components recited herein.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

What is claimed is:

1. A spray system comprising:
an agricultural vehicle;
a spray boom attached to the agricultural vehicle;
a tank that stores a liquid agricultural product;
a plurality of spray nozzles disposed on the spray boom;
a plurality of fluid lines, each fluid line fluidly coupling the tank to a respective spray nozzle and to the tank;
a plurality of valves, each valve fluidly coupled to a respective fluid line and having an open state in which the liquid agricultural product flows from the tank to a respective spray nozzle and a closed state in which a flow of the liquid agricultural product from the tank to the respective spray nozzle is obstructed;
a height sensor disposed on the spray boom; and
one or more processors in communication with the valves and the height sensor, the processor(s) configured to cause the valves to transition between the open state and the closed state at a frequency and a variable duty cycle, the variable duty cycle based at least in part on a measured height of the spray boom.

2. The spray system of claim 1, wherein the processor(s) is/are configured to set the variable duty cycle at a default duty cycle when the measured height is lower than or equal to an upper threshold height and greater than or equal to a lower threshold height.

3. The spray system of claim 2, wherein the processor(s) is/are configured to set the variable duty cycle at a higher duty cycle when the measured height is greater than the upper threshold height, the higher duty cycle higher than the default duty cycle.

4. The spray system of claim 3, wherein the processor(s) is/are configured to set the variable duty cycle at a lower duty cycle when the measured height is lower than the lower threshold height, the lower duty cycle lower than the default duty cycle.

5. The spray system of claim 2, further comprising a plurality of height sensors height disposed on the spray boom,
wherein:
the processor(s) is/are configured to cause first and second valves to operate at a first variable duty cycle, the first variable duty cycle based at least in part on a first measured height of the spray boom at a first position of a first height sensor associated with the first valve, and
the first and second valves are neighboring valves,
such that:
when the first measured height is greater than the upper threshold height, both the first and second valves operate at a higher duty cycle than the default duty cycle,
when the first measured height is lower than the lower threshold height, both the first and second valves operate at a lower duty cycle than the default duty cycle, and
when the first measured height is lower than or equal to the upper threshold height and greater than or equal to the lower threshold height, both the first and second valves operate at the default duty cycle.

6. The spray system of claim 1, wherein the processor(s) is/are configured to:
compare the measured height to a plurality of height-range thresholds, each height-range threshold having a respective upper threshold height and a respective lower threshold height and associated with a respective duty cycle, and
set the variable duty cycle to a first duty cycle when the measured height is within a first height-range threshold.

7. The spray system of claim 1, wherein the processor(s) is/are configured to:
determine a model duty cycle using the measured height and a duty-cycle model, and
set the variable duty cycle to the model duty cycle.

8. The spray system of claim 1, wherein the spray nozzles comprise broadcast nozzles and/or selective spot-spray nozzles.

9. The spray system of claim 1, wherein:
the tank is a broadcast tank that stores a general-application liquid agricultural product,
the fluid lines are first fluid lines,
the spray nozzles are broadcast nozzles,
the valves are first valves,
the frequency is a first frequency,
the variable duty cycle is a first variable duty cycle, and
the system further comprises:
a plurality of selective spot-spray (SSP) nozzles disposed on the spray boom;
an SSP tank that stores a target-application liquid agricultural product;
a plurality of second fluid lines, each second fluid line fluidly coupling the SSP tank to a respective SSP nozzle; and
a plurality of second valves, each second valve fluidly coupled to a respective second fluid line and having the open state and the closed state,
wherein the processor(s) is/are in communication with the second valves, the processor(s) configured to cause the second valves to transition between the open state and the closed state at a second frequency and a second variable duty cycle, the second variable duty cycle based at least in part on the measured height of the spray boom.

10. A spray system comprising:
an agricultural vehicle;
a spray boom attached to the agricultural vehicle;
a tank that stores a liquid agricultural product;
a plurality of spray nozzles disposed on the spray boom;
a plurality of fluid lines, each fluid line fluidly coupling the tank to a respective spray nozzle and to the tank;
a plurality of valves, each valve fluidly coupled to a respective fluid line and having an open state in which the liquid agricultural product flows from the tank to a respective spray nozzle and a closed state in which a flow of the liquid agricultural product from the tank to the respective spray nozzle is obstructed;
a plurality of height sensors disposed on the spray boom, each height sensor associated with a group of the valves; and
one or more processors in electrical communication with the valves and the height sensors, the processor(s) configured to cause each group of valves to transition between the open state and the closed state at a respective frequency and at a respective variable duty cycle, the respective variable duty cycle based at least in part on a respective measured height of the spray boom at a respective position of a respective height sensor.

11. The spray system of claim 10, wherein the processor(s) is/are configured to set the respective variable duty cycle at a default duty cycle when the respective measured height is lower than or equal to an upper threshold height and greater than or equal to a lower threshold height.

12. The spray system of claim 11, wherein the processor(s) is/are configured to set the respective variable duty cycle at a higher duty cycle when the respective measured height is greater than the upper threshold height, the higher duty cycle higher than the default duty cycle.

13. The spray system of claim 12, wherein the processor(s) is/are configured to set the respective variable duty cycle at a lower duty cycle when the respective measured height is lower than the lower threshold height, the lower duty cycle lower than the default duty cycle.

14. The spray system of claim 10, wherein the processor(s) is/are configured to:
compare the respective measured height to a plurality of height-range thresholds, each height-range threshold having a respective upper threshold height and a respective lower threshold height and associated with a corresponding duty cycle, and
set the respective variable duty cycle to a first duty cycle when the respective measured height is within a first height-range threshold.

15. The spray system of claim 10, wherein the processor(s) is/are configured to:
determine a respective model duty cycle using the respective measured height and a duty-cycle model, and
set the respective variable duty cycle to the respective model duty cycle.

16. The spray system of claim 10, wherein the spray nozzles comprise broadcast nozzles and/or selective spot-spray nozzles.

17. A spray system comprising:
an agricultural vehicle;
a spray boom attached to the agricultural vehicle;
a broadcast tank that stores a general-application liquid agricultural product;
a selective-spot sprayer (SSP) tank that stores a specific-application liquid agricultural product;
a plurality of broadcast nozzles disposed on the spray boom;
a plurality of SSP nozzles disposed on the spray boom;
a plurality of first fluid lines, each first fluid line fluidly coupling the broadcast tank to a respective broadcast spray nozzle;
a plurality of second fluid lines, each second fluid line fluidly coupling the SSP tank to a respective SSP spray nozzle;
a plurality of first valves, each first valve fluidly coupled to a respective first fluid line and having an open state and a closed state;
a plurality of second valves, each second valve fluidly coupled to a respective second fluid line and having the open state and the closed state;
a plurality of height sensors disposed on the spray boom, each height sensor associated with a respective group of the first and second valves; and
one or more processors in electrical communication with the first and second valves and the height sensors, the processor(s) configured to:
cause the first valves of each group to transition between the open state and the closed state at a respective first frequency and at a respective first variable duty cycle, the respective first variable duty cycle based at least in part on a respective measured height of the spray boom at a respective position of a respective height sensor, and
cause the second valves of each group to transition between the open state and the closed state at a respective second frequency and at a respective second variable duty cycle, the respective second variable duty cycle based at least in part on the respective measured height of the spray boom.
